(19) United States
(12) Patent Application Publication
(10) Pub. No.: US 2008/0077399 A1
(43) Pub. Date: Mar. 27, 2008

(54) Low-frequency-band voice reconstructing device, voice signal processor and recording apparatus

(75) Inventor: Masahiro Yoshida, Osaka (JP)

Correspondence Address: MOTS LAW, PLLC, 1001 PENNSYLVANIA AVE. N.W., SOUTH, SUITE 600, WASHINGTON, DC, 20004, US

(73) Assignee: Sanyo Electric Co., Ltd., Moriguchi City (JP)

(21) Appl. No.: 11/902,210

(22) Filed: Sep. 20, 2007

(30) Foreign Application Priority Data
Sep. 25, 2006 (JP) JP2006-259217

(51) Int. Cl. G10L 11/06

(52) U.S. Cl. 704/208

(57) ABSTRACT

There is provided a low-frequency-band voice reconstructing device. A voice signal from which a signal in a low-frequency band is removed is inputted to the device and the device reconstructs the signal in the low frequency band based on the input voice signal. The device comprises a first portion for extracting part of harmonic components of a pitch signal of voice from the input voice signal, a second portion for squaring a signal extracted by the first portion, a third portion for extracting a signal of a pitch frequency and harmonic signals of a lower limit frequency or below of the input voice signal, from the signal obtained by the second portion, and a fourth portion for correcting an amplitude level of the signal extracted by the third portion.

### BACKGROUND OF THE INVENTION

1. Field of the Invention

The present invention relates to a low-frequency-band voice reconstructing device, a voice signal processor and a recording apparatus.

2. Description of the Related Art

The fundamental frequency of human voice (pitch frequency) is approximately between 90 Hz and 160 Hz for male, and between 230 Hz and 370 Hz for female. This is a very important factor to determine tone quality. In telephones, however, voice in the 300 Hz band or below is generally cut off. Video cameras and IC (integrated circuit) recorders use a high-pass filter with a cutoff frequency of around 300 Hz to reduce the impact of wind noise, so that low-frequency components are cut off for each voice signal. Lack of pitch information may lead to a change in tone quality, which will prevent natural voice from being reproduced.

One method for reconstructing lost pitch information for a low frequency band is the Speech Bandwidth Extension as described in Japanese Unexamined Patent Application Publication (Translation of PCT Application) No. 2004-517368. This conventional method requires complicated frequency analysis and a lot of processings, and even a memory of large capacity, presenting a drawback of higher costs.

### SUMMARY OF THE INVENTION

An object of the present invention is to provide a low-frequency-band voice reconstructing device and a recording apparatus, capable of reducing a processing amount and saving a memory capacity.

Another object of the present invention is to provide a voice signal processor and a recording apparatus, capable of adaptively controlling a mixing rate, in accordance with the level of wind noise, for mixing an original low-frequency sound and a reconstructed low-frequency sound with a signal obtained by removing low-frequency components from the original sound, thereby achieving appropriate quality of low tone.

A first low-frequency-band voice reconstructing device according to the present invention is a device to which a voice signal obtained by removing a signal in a low frequency band is inputted, the device reconstructing the signal in the low frequency band based on the input voice signal, comprising: first means for extracting part of harmonic components of a pitch signal of voice from the input voice signal; second means for squaring a signal extracted by the first means; third means for extracting a signal of a pitch frequency and harmonic signals of a lower limit frequency or below of the input voice signal, from the signal obtained by the second means; and fourth means for correcting an amplitude level of the signal extracted by the third means.

The fourth means in the first low-frequency-band voice reconstructing device comprises, for example, means for calculating a correction value based on a level of the signal extracted by the first means, and means for correcting the amplitude level of the signal extracted by the third means based on the calculated correction value.

A second low-frequency-band voice reconstructing device according to the present invention is a device to which a voice signal obtained by removing a signal in a low frequency band is inputted, the device reconstructing the signal in the low frequency band based on the input voice signal, comprising: first means for extracting part of harmonic components of a pitch signal of voice from the input voice signal; second means for squaring a signal extracted by the first means; third means for correcting an amplitude level of the signal obtained by the second means; and fourth means for extracting a signal of a pitch frequency and harmonic signals of a lower limit frequency or below of the input voice signal, from the signal obtained by the third means.

The third means in the second low-frequency-band voice reconstructing device comprises, for example, means for calculating a correction value based on a level of the signal extracted by the first means, and means for correcting the amplitude level of the signal extracted by the second means based on the calculated correction value.

A voice signal processor according to the present invention comprises: wind noise determining means for determining a level of wind noise contained in an input voice signal, based on the input voice signal; low-frequency-band signal extracting means for extracting a signal in a low frequency band of a given frequency or below, from the input voice signal; high-frequency-band signal extracting means for extracting a signal in a high frequency band of the given frequency or above, from the input voice signal; low-frequency-band voice reconstructing means for reconstructing the low-frequency-band signal contained in the input voice signal based on the high-frequency-band signal extracted by the high-frequency-band signal extracting means, the low-frequency-band signal being of the given frequency or below; adjusting means for adjusting a rate of adding the low-frequency-band signal extracted by the low-frequency-band signal extracting means and the low-frequency-band signal generated by the low-frequency-band voice reconstructing means, to the high-frequency-band signal, in accordance with the level of wind noise determined by the wind noise determining means; and adding means for adding both of the low-frequency-band signals after the adjustment by the adjusting means, to the high-frequency-band signal.

One example of the adjusting means is means which adjusts the rate of adding both of the low-frequency-band signals to the high-frequency-band signal, such that when the level of wind noise determined by the wind noise determining means is large, the rate of adding the low-frequency-band signal generated by the low-frequency-band voice reconstructing means to the high-frequency-band signal is made larger than the rate of adding the low-frequency-band signal extracted by the low-frequency-band signal extracting means to the high-frequency-band signal, and when the level of wind noise determined by the wind noise determining means is small, the rate of adding the low-frequency-band signal extracted by the low-frequency-band signal extracting means to the high-frequency-band signal is made larger than the rate of adding the low-frequency-band signal generated by the low-frequency-band voice reconstructing means to the high-frequency-band signal.

A first recording apparatus according to the present invention comprises any one of the first and second low-frequency-band voice reconstructing devices.

A second recording apparatus according to the present invention comprises the aforementioned voice signal processor.

### BRIEF DESCRIPTION OF THE DRAWINGS

FIG. 1 is a block diagram illustrating the configuration of a voice signal processing circuit comprising a device for reconstructing voice in a low frequency band;

FIG. 2 is a graph showing an example of the spectral characteristics of an input voice signal.

FIG. 3 is a block diagram illustrating the configuration of a voice signal processing circuit comprising a device for reconstructing voice in a low frequency band;

FIG. 4 is a block diagram showing a modification of the voice signal processing circuit of FIG. 3;

FIG. 5 is a graph showing the spectra of a signal containing an 800 Hz signal and a 1 KHz signal; and

FIG. 6 is a graph showing the spectra of a signal outputted from a full-wave rectifying portion 16 in a case where the signal as shown in FIG. 5 is inputted to the full-wave rectifying portion 16.

### DETAILED DESCRIPTION OF THE PREFERRED EMBODIMENTS

Hereinafter, embodiments of the present invention will be described with reference to the drawings.

### [1] First Embodiment

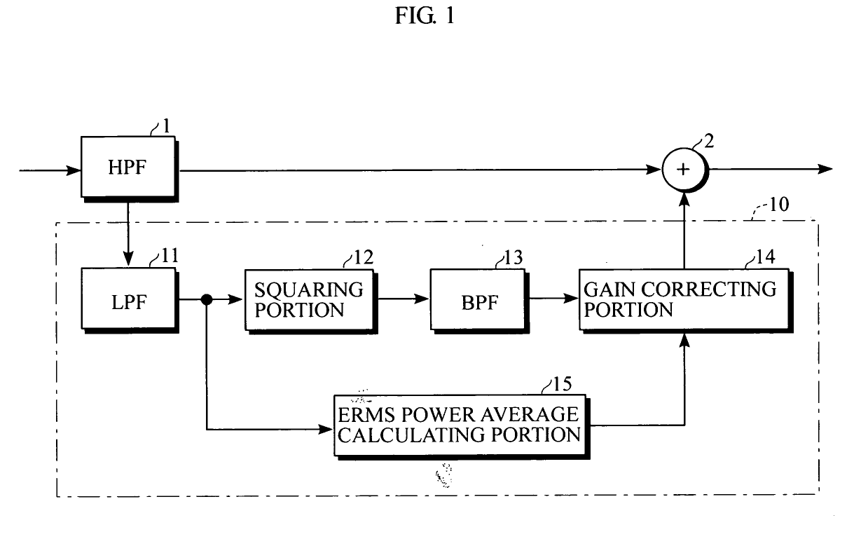

FIG. 1 illustrates the configuration of a voice signal processor comprising a device for reconstructing voice in a low frequency band.

An input signal is sent to a high-pass filter (HPF) 1 to suppress the influence of wind noise. As an example of the HPF 1, an HPF with a cutoff frequency of 300 Hz is used here. A voice signal passed through the HPF 1 is supplied to a device for reconstructing voice in a low frequency band (hereinafter referred to as “low-frequency-band voice reconstructing device”) 10 and to an adder 2 as well. A voice signal reconstructed by the low-frequency-band voice reconstructing device 10 is sent to the adder 2, where the signal is added to the voice signal passed through the HPF 1.

The low-frequency-band voice reconstructing device 10 includes a low-pass filter (LPF) 11, a squaring portion 12, a band-pass filter (BPF) 13, a gain correcting portion 14 and an ERMS power average calculating portion 15. As an example of the LPF 11, an LPF having a cutoff frequency of 600 Hz is used here.

The voice signal passed through the HPF 1 is sent via the LPF 11 to the squaring portion 12 in the low-frequency-band voice reconstructing device 10. The cutoff frequency of the HPF 1 is 300 Hz, while the cutoff frequency of the LPF 11 is 600 Hz. Therefore, an input signal to the squaring portion 12 is a signal in the frequency band of 300 Hz to 600 Hz.

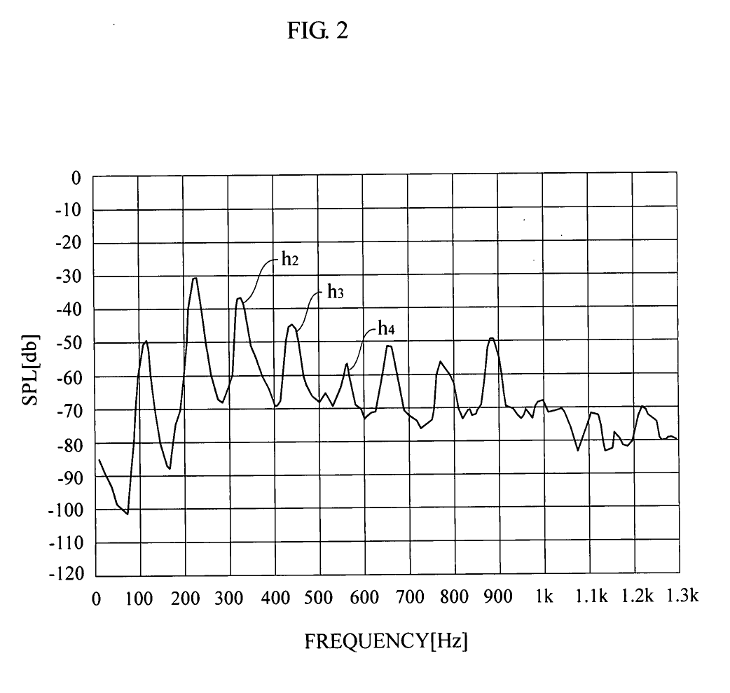

Take a look at an input voice signal having a harmonic structure as shown in FIG. 2, for example. In this case, a signal including the second harmonic component h₂, the third harmonic component h₃ and the fourth harmonic component h₄ is inputted to the squaring portion 12. The squaring portion 12 squares this input signal to generate signals of frequencies corresponding to the differences among, and the sums of, the frequencies of the respective harmonic components.

Specifically, the signal INₜ² obtained by squaring the harmonic signal INₜ, which contains the second, third and fourth harmonic components, can be expressed by the following formula (1), where ω₀ represents a pitch frequency, Gₙ denotes an amplitude level of the n-th harmonic component, and t indicates time:

$$\begin{matrix}{IN}_{t}^{2} = {( {\sum }_{n = 2}^{4} {G}_{n} sin {ω}_{0} \cdot ( n + 1 ) \cdot t )}^{2} \\ = ( {G}_{2}^{2} / 2 ) ( 1 - cos {ω}_{0} \cdot 6 \cdot t ) + \\ ( {G}_{3}^{2} / 2 ) ( 1 - cos {ω}_{0} \cdot 8 \cdot t ) + \\ ( {G}_{4}^{2} / 2 ) ( 1 - cos {ω}_{0} \cdot 10 \cdot t ) + \\ {G}_{2} \cdot {G}_{3} \{ ( cos {ω}_{0} \cdot t ) - ( cos {ω}_{0} \cdot 7 \cdot t ) \} + \\ {G}_{3} \cdot {G}_{4} \{ ( cos {ω}_{0} \cdot t ) - ( cos {ω}_{0} \cdot 9 \cdot t ) \} + \\ {G}_{4} \cdot {G}_{2} \{ ( cos {ω}_{0} \cdot 2 \cdot t ) - ( cos {ω}_{0} \cdot 8 \cdot t ) \}\end{matrix} \qquad ( 1 )$$

A signal obtained by the squaring portion 12 is sent to the BPF 13. As an example of the BPF 13, a BPF with a pass band of 50 to 300 Hz is used here. In this example, the pitch frequency ω₀ is approximately 110 Hz. Therefore, a bias component and a high-frequency component are removed by the BPF 13 from the signal expressed by the above formula (1), INₜ², and a signal indicated by the following formula (2), SL′ₜ, is outputted from the BPF 13:

SL′ₜ=G₂·G₃(cos ω₀·t)+G₃·G₄(cos ω₀·t)+G₄·G₂(cos ω₀·2·t) (2)

The ERMS power average calculating portion 15 calculates a correction value GHₜ reflecting an average value of G₂, G₃ and G₄, based on the signal passed through the LPF 11, INₜ. The correction value GHₜ is calculated using the following formula (3), where K is a constant, which is 0.9 in this example:

GHₜ=\sqrt{G_{—}AVₜ}

G_{—}AVₜ=G_{—}AVₜ₋₁·K+INₜ² (3)

The output from the BPF 13, SL′ₜ, is supplied to the gain correcting portion 14. The gain correcting portion 14 is provided with the correction value GHₜ calculated by the ERMS power average calculating portion 15. The gain correcting portion 14 divides the output signal of the BPF 13, SL′ₜ, by the correction value GHₜ, to subject the signal SL′ₜ to gain correction. This enables the reconstruction of a signal at a frequency ω₀ and at a frequency 2·ω₀, which are 300 Hz or below.

A signal obtained by the gain correcting portion 14, SLₜ (=SL′ₜ/GHₜ), is fed to the adder 2, where SLₜ is added to the signal passed through the HPF 1 (the signal from which a signal of 300 Hz or below is removed).

In the above-described embodiment, gain correction is made by the gain correcting portion 14 on the signal passed through the BPF 13. However, gain correction by the gain correcting portion 14 may be performed on the output signal from the squaring portion 12, and then a signal obtained by the gain correcting portion 14 may be sent to the BPF 13.

According to the aforementioned embodiment, even if a low-frequency component contained in an input voice signal is removed by a high-pass filter due to the necessity of alleviating the influence of wind noise or the like, it is possible to reconstruct the pitch information of voice contained in the removed signal and its harmonic tone signals. Wind noise is not reconstructed like the pitch information, since wind noise does not have a harmonic structure.

A high-pass filter (HPF 1) is not required for a signal transmitted from a telephone or the like, since a low-frequency signal has originally been removed. Even in this case, it is possible to reconstruct the pitch information of voice contained in the originally removed signal and its harmonic tone signals.

Moreover, since gain correction is made in accordance with the average level of the signal to be inputted to the squaring portion 12, natural tone quality can be achieved. Furthermore, the reconstruction of the pitch information of voice can be ensured, since the input to the squaring portion 12 is limited to a signal in a frequency band mainly containing the frequencies of voice, by using the low-pass filter (LPF 11).

Each element in FIG. 1 may be implemented by hardware or by software.

### [2] Second Embodiment

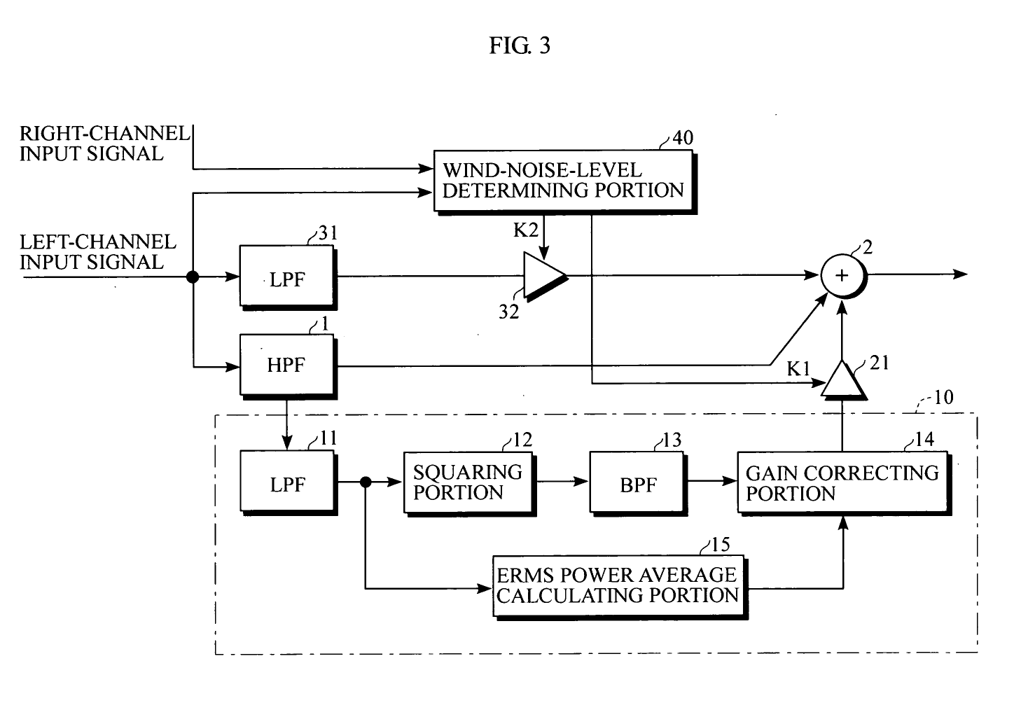

FIG. 3 illustrates the configuration of a voice signal processing circuit comprising a device for reconstructing voice in a low-frequency band.

This voice signal processing circuit is capable of mixing an original sound of 300 Hz or above with a signal of 300 Hz or below, obtained by the device for reconstructing voice in a low frequency band (hereinafter referred to as “low-frequency-band voice reconstructing device”), and also with an original sound of 300 Hz or below. To do so, the level of wind noise is determined to adaptively control the mixing rate, in accordance with the wind noise level, for mixing the original sound of 300 Hz or below and the signal of 300 Hz or below, which is obtained by the low-frequency-band voice reconstructing device, with the original sound of 300 Hz or above.

The voice signal processing circuit as shown in FIG. 3 is a circuit for a left-channel input signal in a stereophonic input signal. A voice signal processing circuit for a right-channel input signal (not shown) is the same as that for left channel. In FIG. 3, the same reference numerals are given to the same elements as those of FIG. 1, and their descriptions will be omitted.

In FIG. 3, a first multiplier 21 is provided between the adder 2 and the gain correcting portion 14 to adjust a mixing amount. That is, a reconstructed signal obtained by the gain correcting portion 14 is sent to the adder 2 via the first multiplier 21.

In addition, a low-pass filter (LPF) 31 is provided to extract a signal of 300 Hz or below from the left-channel input signal. That is, an LPF with a cutoff frequency of 300 Hz is used here, as an example of the LPF 31. A signal passed through the LPF 31 is supplied to the adder 2 via a second multiplier 32 for adjusting a mixing amount.

Furthermore, a wind-noise-level determining portion 40 is provided to determine the level of wind noise based on the left-channel input signal and the right-channel input signal and to set multiplier coefficients K1 and K2 for the first and second multipliers 21 and 32, respectively.

The left-channel input signal is sent to the HPF 1 to suppress the impact of wind noise and also to the LPF 31. A voice signal passed through the HPF 1 is fed to the low-frequency-band voice reconstructing device 10 and to the adder 2 as well. A voice signal reconstructed by the low-frequency-band voice reconstructing device 10 is sent to the first multiplier 21, which multiplies the voice signal by the multiplier coefficient K1. An output signal from the first multiplier 21 is sent to the adder 2. A signal passed through the LPF 31 (an original-sound signal of 300 Hz or below) is sent to the second multiplier 32, which multiplies the signal by the multiplier coefficient K2. An output signal from the second multiplier 32 is supplied to the adder 2. The adder 2 mixes the voice signal passed through the HPF 1 with the output signal from the first multiplier 21 and the output signal from the second multiplier 32.

The wind-noise-level determining processing and the multiplier coefficient setting processing are described below.

First, description is provided of the wind-noise-level determining processing. In this example, the strength of correlation between a left-channel low-frequency signal and a right-channel low-frequency signal is calculated to determine the input signal to be wind noise when the correlation is low, while determining the signal to be a normal sound (target sound) when the correlation is high.

Because the spacing between left and right microphones is short, and the lower frequency band is targeted, the strength of correlation, Hs, between the left-channel low-frequency signal and the right-channel low-frequency signal is calculated in simplified manner, based on the following evaluation formula (4):

$${H}_{s} = ( 2 / N ) \cdot {\sum }_{t = 0}^{N - 1} \{ ( {IN\_Lch}_{t} \times {IN\_Rch}_{t} ) / ( {IN\_Lch}_{t}^{2} + {IN\_Rch}_{t}^{2} ) \} \qquad ( 4 )$$

In the above formula (4), IN_Lchₜ indicates a left-channel input signal of 100 Hz or below at the time t, and IN_Rchₜ shows a right-channel input signal of 100 Hz or below at the time t.

Next, the multiplier coefficient setting processing is described. The multiplier coefficient K1 to be supplied to the first multiplier 21 and the multiplier coefficient K2 to the second multiplier 32 are determined in accordance with the strength of correlation, Hs. The maximum value of the strength of correlation Hs is 1.0. As the strength of correlation Hs increases, it is more likely that the signal will be a normal sound (target sound). Therefore, K2 is increased, while K1 is decreased. Here, K1 is set at (1−Hs), and K2 is set at Hs.

Consequently, in order to mix the signal passed through the LPF 31 (the original-sound signal of 300 Hz or below) and the voice signal reconstructed by the low-frequency-band voice reconstructing device 10 with the signal of 300 Hz or above passed through the HPF 1 (the original sound of 300 Hz or above), the rate of mixing the signal passed through the LPF 31 is made larger than the rate of mixing the voice signal reconstructed by the low-frequency-band voice reconstructing device 10, when Hs is large and wind noise is small. In reverse, the rate of mixing the voice signal reconstructed by the low-frequency-band voice reconstructing device 10 is made larger than the rate of mixing the signal passed through the LPF 31, when Hs is small and wind noise is large.

According to the second embodiment described above, the mixing rate for mixing the original low-frequency sound and the reconstructed low-frequency sound with the signal obtained by removing the low-frequency components from the original sound is controlled adaptively in accordance with the level of wind noise. Therefore, appropriate quality of low tone can be achieved.

It is noted that a low-frequency-band voice reconstructing device other than that of the first embodiment may be used in FIG. 3.

Each element of FIG. 3 may be implemented by hardware or by software.

### [3] Third Embodiment

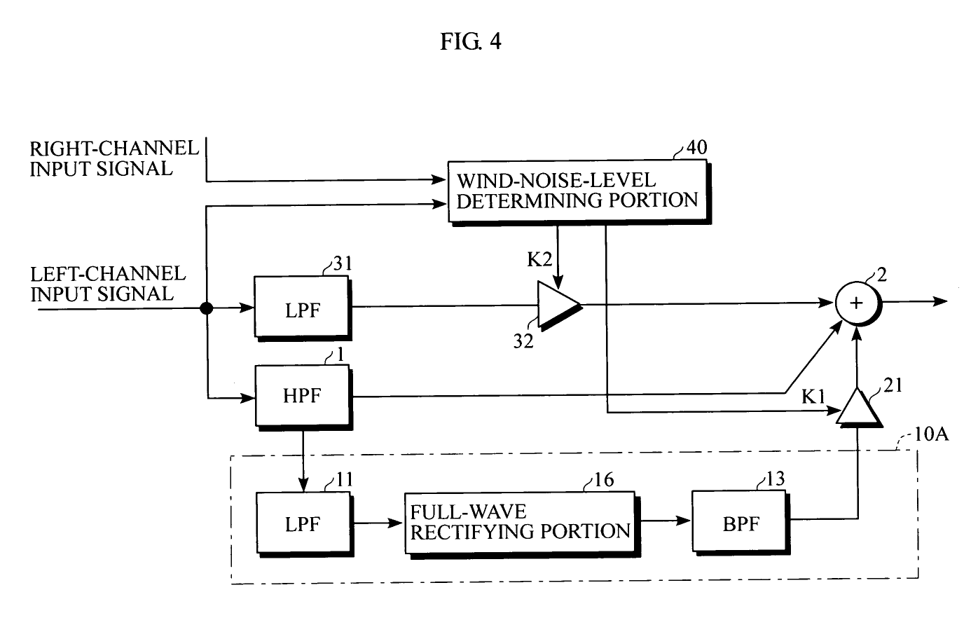

FIG. 4 shows the third embodiment.

In FIG. 4, the same elements as those of FIG. 3 are identified with the same reference numerals, and their descriptions will be omitted.

The voice signal processing circuit of FIG. 4 differs from the circuit of FIG. 3 in that a low-frequency-band voice reconstructing device 10A is employed.

This low-frequency-band voice reconstructing device 10A comprises the LPF 11, a full-wave rectifying portion (full-wave rectifying circuit) 16 and the BPF 13. As an example of the LPF 11, an LPF having a cutoff frequency of 600 Hz is used here. As an example of the BPF 13, a BPF with a pass band of 50 to 300 Hz is utilized here.

A voice signal passed through the HPF 1 is sent to the full-wave rectifying portion 16 via the LPF 11 in the low-frequency-band voice reconstructing device 10A. The cutoff frequency of the HPF 1 is 300 Hz, while the cutoff frequency of the LPF 11 is 600 Hz. Therefore, an input signal to the full-wave rectifying portion 16 is a signal in the 300-600 Hz band.

The full-wave rectifying portion 16 generates signals corresponding to the difference frequencies among a plurality of spectra contained in the signal passed through the LPF 11 (hereinafter referred to as “difference frequency signal”), and harmonic signals of the difference frequency signals.

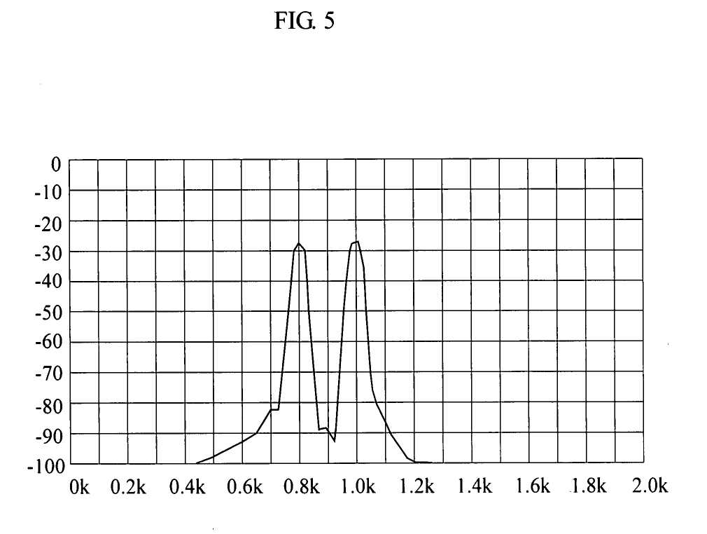

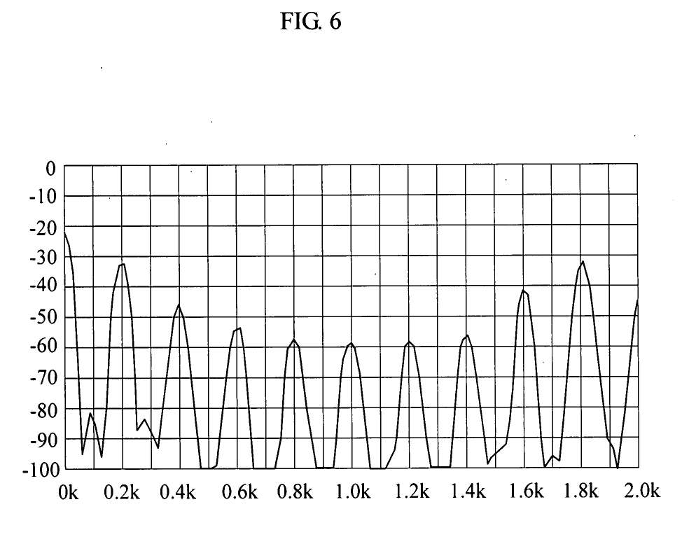

For example, when a signal containing a 800 Hz signal and a 1 KHz signal as shown in FIG. 5 is inputted to the full-wave rectifying portion 16, the full-wave rectifying portion 16 outputs a signal of 200 Hz that is the difference frequency between the spectra contained in the input signal, and its harmonic signals, as shown in FIG. 6.

The difference frequency signal and its harmonic signal components produced by the full-wave rectifying portion 16 are supplied to the BPF 13, where difference frequency components within a range between 50-300 Hz are extracted. As a result, a voice signal in a low frequency band not higher than 300 Hz, which has been cut off by the HPF 1, is reconstructed.

The third embodiment does not require the gain correcting portion 14 and the ERMS power average calculating portion 15 in FIG. 3, as compared with the second embodiment. This provides the merit of simplifying the configuration and reducing the processing amount.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A low-frequency-band voice reconstructing device, to which a voice signal obtained by removing a signal in a low-frequency band is inputted, the device reconstructing the signal in the low frequency band based on the input voice signal, comprising:
first means for extracting part of harmonic components of a pitch signal of voice from the input voice signal;
second means for squaring a signal extracted by the first means;
third means for extracting a signal of a pitch frequency and harmonic signals of a lower limit frequency or below of the input voice signal, from the signal obtained by the second means; and
fourth means for correcting an amplitude level of the signal extracted by the third means.

2. The low-frequency-band voice reconstructing device according to claim 1, wherein the fourth means comprises:
means for calculating a correction value based on a level of the signal extracted by the first means; and
means for correcting the amplitude level of the signal extracted by the third means based on the calculated correction value.

3. A low-frequency-band voice reconstructing device, to which a voice signal obtained by removing a signal in a low frequency band is inputted, the device reconstructing the signal in the low frequency band based on the input voice signal, comprising:
first means for extracting part of harmonic components of a pitch signal of voice from the input voice signal;
second means for squaring a signal extracted by the first means;
third means for correcting an amplitude level of the signal obtained by the second means; and
fourth means for extracting a signal of a pitch frequency and harmonic signals of a lower limit frequency or below of the input voice signal, from the signal obtained by the third means.

4. The low-frequency-band voice reconstructing device according to claim 3, wherein the third means comprises:
means for calculating a correction value based on a level of the signal extracted by the first means; and
means for correcting the amplitude level of the signal extracted by the second means based on the calculated correction value.

5. A voice signal processor comprising:
wind noise determining means for determining a level of wind noise contained in an input voice signal, based on the input voice signal;
low-frequency-band signal extracting means for extracting a signal in a low frequency band of a given frequency or below, from the input voice signal;
high-frequency-band signal extracting means for extracting a signal in a high frequency band of the given frequency or above, from the input voice signal;
low-frequency-band voice reconstructing means for reconstructing the low-frequency-band signal contained in the input voice signal based on the high-frequency-band signal extracted by the high-frequency-band signal extracting means, the low-frequency-band signal being of the given frequency or below;
adjusting means for adjusting a rate of adding the low-frequency-band signal extracted by the low-frequency-band signal extracting means and the low-frequency-band signal generated by the low-frequency-band voice reconstructing means, to the high-frequency-band signal, in accordance with the level of wind noise determined by the wind noise determining means; and
adding means for adding both of the low-frequency-band signals after the adjustment by the adjusting means, to the high-frequency-band signal.

6. The voice signal processor according to claim 5, wherein
the adjusting means adjusts the rate of adding both of the low-frequency-band signals to the high-frequency-band signal, such that
when the level of wind noise determined by the wind noise determining means is large, the rate of adding the low-frequency-band signal generated by the low-frequency-band voice reconstructing means to the high-frequency-band signal is made larger than the rate of adding the low-frequency-band signal extracted by the low-frequency-band signal extracting means to the high-frequency-band signal, and
when the level of wind noise determined by the wind noise determining means is small, the rate of adding the low-frequency-band signal extracted by the low-frequency-band signal extracting means to the high-frequency-band signal is made larger than the rate of adding the low-frequency-band signal generated by the low-frequency-band voice reconstructing means to the high-frequency-band signal.

7. A recording apparatus comprising any one of the low-frequency-band voice reconstructing devices according to claims 1, 2, 3 and 4.

8. A recording apparatus comprising any one of the voice signal processors according to claims 5 and 6.
